(19) United States
(12) Patent Application Publication
(10) Pub. No.: US 2010/0075842 A1
(43) Pub. Date: Mar. 25, 2010

(54) POTASSIUM OXIDE-INCORPORATED ALUMINA CATALYSTS WITH ENHANCED STORAGE CAPACITIES OF NITROGEN OXIDE AND A PRODUCING METHOD THEREFOR

(76) Inventors: Hyun-Sik Han, Ansan City (KR); Gon Seo, Gwangju-city (KR); Young-San Yoo, Shiheung-City (KR); Se-Min Park, Yeosu si (KR)

Correspondence Address: Ballard Spahr LLP, SUITE 1000, 999 PEACHTREE STREET, ATLANTA, GA, 30309-3915, US

(21) Appl. No.: 12/447,356

(22) PCT Filed: Nov. 19, 2006
(86) PCT No.: PCT/KR2007/005809

§ 371 Date: Apr. 27, 2009

(30) Foreign Application Priority Data
Nov. 29, 2006 (KR) 102006 0118940

(51) Int. Cl. B01J 23/58; B01J 23/04; B01J 23/02

(52) U.S. Cl. 502/328; 502/344; 502/341; 502/330

(57) ABSTRACT

Disclosed herein is a method of producing a catalyst for storing nitrogen oxides, including: supporting a potassium oxide on alumina, which serves as a support, and then calcining the alumina supported with the potassium oxide at a high temperature, thus chemically bonding potassium oxide with the alumina. The method is advantageous in that a catalyst for storing nitrogen oxides, having high nitrogen oxide storage capacity and excellent hydrothermal stability, can be produced at low cost through a simple process.

### TECHNICAL FIELD

The present invention relates to an alumina catalyst chemically bonded with potassium oxide and a method of producing the catalyst, and, more particularly, to a catalyst for storing nitrogen dioxide, which includes potassium oxide chemically bonded with alumina, which is a support, and which has high nitrogen dioxide storage capacity and hydrothermal stability.

### BACKGROUND ART

The present invention relates to a catalyst which can be used for a NOx storage and reduction (NSR) apparatus for efficiently storing and removing nitrogen oxides (NOx) present in exhaust gases discharged from diesel automobiles. A large amount of oxygen is included in exhaust gases discharged from diesel engines burning fuel in an excess oxygen atmosphere. Exhaust gases discharged from diesel engines, unlike exhaust gases discharged from gasoline engines, include more oxidizing substances, such as oxygen, nitrogen oxides, etc., than reducing substances, such as unburned hydrocarbons, carbon monoxide, etc. Therefore, even when three-way catalysts, commonly used for gasoline engines, are used to remove exhaust gases, they cannot be removed at one time, because an oxidation-reduction reaction is not balanced. That is, since excess oxygen is present in exhaust gases, unburned hydrocarbons or carbon monoxide can be easily removed using a catalyst, but nitrogen oxides, which must be reduced, cannot be easily removed.

In order to solve the above problem, as a conventional method of removing nitrogen oxides, a method of removing nitrogen oxides by additionally supplying urea, serving as a reductant, to exhaust gases to reduce the nitrogen oxides is known in the art. This method is a method of removing nitrogen oxides by reducing the nitrogen oxides using ammonia obtained by hydrolyzing urea, and is referred to as a urea-selective catalytic reduction (Urea-SCR)) method, because harmless urea is used as a reductant, instead of strongly toxic ammonia. Ammonia has strong reducing ability and thus can efficiently reduce and remove nitrogen oxides, but is problematic in that additional equipment, such as a urea injection apparatus, a hydrolysis reactor, a storage apparatus, etc., is required, and social infrastructure, such as a sales network for a urea aqueous solution, etc., is required to be established, and thus the introduction of a Urea-SCR method as a diesel automobile exhaust gas purification method is delayed.

Meanwhile, a method of reducing and removing nitrogen oxides by storing nitrogen oxides in exhaust gases in a catalyst and then injecting fuel into the catalyst at regular intervals, thus desorbing the nitrogen oxides stored in the catalyst in an oxidation atmosphere, called “a NOx storage and reduction (NSR) method”, is being commercially used. In this method, in an oxidation atmosphere, nitrogen oxides are stored in barium oxide, which is supported on alumina, and in a reduction atmosphere, formed due to the injection of fuel, the nitrogen oxides are desorbed. The injected fuel is decomposed into reducing substances by precious metals supported on alumina together with barium oxide, and the reducing substances reduce and remove the desorbed nitrogen oxides. Unlike the Urea-SCR method, the NSR method is convenient in that nitrogen oxides are removed by the injection of fuel, and thus additional facilities for storing and supplying urea or specific chemicals are not required, but is problematic in that since a large amount of fuel is used in order to convert exhaust gas to a reduction atmosphere, the air-fuel ratio becomes low, and since a large amount of nitrogen oxides is stored in a catalyst so that the regeneration cycle of a catalyst is increased, which means that the volume of a catalyst must be increased. Considering the above points, the NSR method is suitable for removing nitrogen oxides from exhaust gases emitted from small and middle sized automobiles, which are more difficult to be provided with additional facilities than large sized automobiles.

The performance of an NSR catalyst is primarily evaluated by the amount of the nitrogen oxides stored in the catalyst. Further, the NSR catalyst must have high hydrothermal stability, because exhaust gases to be purified by an automobile purification catalyst contain a large amount of water and are exposed to violent temperature variation. Since nitrogen oxides are stored and then removed, as the storage amount of nitrogen oxide in the catalyst is increased, the storage time thereof is also increased. Considering these facts, the NSR catalyst must store a large amount of nitrogen oxides, have a stable structure, and be produced at low cost so as to increase price competitiveness. Further, in order to efficiently reduce the nitrogen oxides desorbed from the catalyst in a reduction atmosphere, precious metals are also required to be stably dispersed in the catalyst, thereby improving the performance of the NSR catalyst.

### DISCLOSURE OF INVENTION

### Technical Problem

As conventional nitrogen oxide storage materials of the NSR catalyst, barium oxides have been used. Further, it is commonly known that, when alkali metal oxides, such as potassium oxide, etc., are supported on alumina, which is a support, alkalinity is increased, and thus the storage amount of nitrogen oxides is also increased. However, when a catalyst, including alumina supported with alkali metal oxides, is heat-treated in a flow of gases including water vapor, there is a problem in that alkali metal oxides are eluted or clustered, thus decreasing the storage amount of nitrogen dioxide. That is, when alkali metal oxides are supported on the catalyst through general methods, the storage amount of nitrogen dioxide is effectively increased, but hydrothermal stability is decreased, and thus the catalyst including alumina supported with alkali metal oxides is not appropriate for use as an NSR catalyst.

### Technical Solution

The present inventors found that the above problems could be solved by chemically bonding alkali metal oxides with alumina through high-temperature calcination instead of supporting alkali metal oxides on the surface of alumina. That is, since alkali metal oxides are chemically bonded with alumina, the storage amount of nitrogen oxide is increased and the thermal stability thereof is remarkably improved. Furthermore, the present inventors found that, when a small amount of barium oxide was supported on the alumina chemically bonded with alkali metal oxides, the storage amount of nitrogen oxides could be increased, and simultaneously, the hydrothermal stability of the alkali metal oxides could also be improved. Moreover, the present inventors found that, when precious metals were supported on the alumina chemical bonded with alkali metal oxides, the dispersion state of precious metals was improved and stabilized, and thus the ability of the NSR catalyst to withstand heat treatment was also improved.

### ADVANTAGEOUS EFFECTS

The catalyst including alumina chemically bonded with potassium oxide is advantageous in that it has high nitrogen oxide storage capacity and excellent hydrothermal stability and improves the dispersity of precious metals, and particularly, it can be produced at low cost through a simple process.

### BRIEF DESCRIPTION OF THE DRAWINGS

FIG. 1 shows X-ray diffraction patterns of a catalyst (K₂O(0.70)-Al₂O₃) including alumina bonded with potassium oxide and a catalyst (BaO(0.50)/Al₂O₃) including alumina supported with barium oxide;

FIG. 2 shows infrared absorption spectra measured when nitrogen dioxide (5 Torr) was stored in an NSR catalyst, which was not hydrothermally treated, at a temperature of 200° C. and when the NSR catalyst was treated using hydrogen (15 Torr) at a temperature of 200° C.; and

FIG. 3 shows infrared absorption spectra measured when nitrogen dioxide (5 Torr) was stored in an NSR catalyst, which was hydrothermally treated, at a temperature of 200° C. and when the NSR catalyst was treated using hydrogen (15 Torr) at a temperature of 200° C.

### BEST MODE FOR CARRYING OUT THE INVENTION

The present invention provides a method of producing a catalyst for storing nitrogen oxides, including: supporting a potassium oxide on alumina, which serves as a support, and then calcining the alumina supported with the potassium oxide at a high temperature, thus chemically bonding potassium oxide with the alumina.

The method of the present invention may further include supporting barium oxide on the alumina.

The method of the present invention may further include supporting precious metals, such as platinum, palladium, rhodium and the like.

In the method of the present invention, the chemical bonding of the potassium oxide with the alumina may be conducted at a temperature of 750˜1000° C.

In the method of the present invention, the amount of potassium oxide chemically bonded with the alumina may be 0.5˜10 mmol/g; the amount of barium oxide supported with the alumina may be 1˜5 mmol/g; and the amount of platinum or palladium supported with the alumina may be 0.5˜2 wt %.

Further, the present invention provides a catalyst for storing nitrogen oxides, produced using the above method. In the catalyst, the increase in the amount of nitrogen oxides, the improvement of hydrothermal stability and the improvement of the dispersion state can be expected.

### MODE FOR THE INVENTION

A better understanding of the present invention may be obtained through the following examples, which are set forth to illustrate, but are not to be construed as the limit of the present invention.

### Example 1

### Production of K₂O(0.70)-Al₂O₃ Catalyst

20 g of γ-alumina was added to a solution formed by dissolving 2.86 g of potassium nitrate in 200 g of water to form a mixed solution. The mixed solution was sufficiently stirred for 2 hours, and then water was removed therefrom using a rotation evaporator. Subsequently, the resulting product was dried at a temperature of 100° C., and was then calcined in an electrical calcination furnace at a temperature of 850° C. for 4 hours to produce a catalyst including alumina chemically bonded with potassium oxide. In the produced catalyst, the amount of potassium oxide bonded with alumina was 0.70 mmol/galumina, and the catalyst was represented by K₂O(0.70)-Al₂O₃ catalyst.

### Comparative Example 1

### Production of BaO(0.50)/Al₂O₃ and K₂O(0.70)/Al₂O₃ Catalyst

In order to compare storage performance, a catalyst including alumina supported with barium oxide and a catalyst including alumina supported with potassium oxide were also produced. 20 g of γ-alumina was added to a solution formed by dissolving 2.58 g of barium acetate in 200 g of water to form a mixed solution. The mixed solution was sufficiently stirred for 2 hours, and then water was removed therefrom using a rotation evaporator. Subsequently, the resulting product was calcined in an electrical calcination furnace at a temperature of 550° C. for 4 hours to produce a catalyst including alumina supported with barium oxide. In the produced catalyst, the amount of barium oxide, supported with alumina, was 0.50 mmol/galumina, and the catalyst was represented by BaO(0.50)/Al₂O₃ catalyst. Further, a catalyst including alumina supported with potassium oxide was produced using a solution formed by dissolving 2.58 g of potassium nitrate in 200 g of water, instead of barium acetate, as above. In the produced catalyst, the amount of potassium oxide supported with alumina was 0.70 mmol/galumina, and the catalyst was represented by K₂O(0.70)-Al₂O₃ catalyst.

The storage amounts of nitrogen dioxide in the catalysts of Example 1 and Comparative Example 1 were measured. In the measurement of the storage amounts, catalysts were mounted on a weight type adsorber provided with a quartz spring, and were then exposed to exhaust gases discharged from a diesel automobile at a temperature of 300° C. for 1 hour, considering the temperature of the exhaust gases. Subsequently, nitrogen dioxide of 20 Torr was applied to the catalysts at a temperature of 200° C., and the catalysts were left for 1 hour in order to sufficiently store the nitrogen dioxide, and then the amounts of nitrogen dioxide stored in the catalysts were calculated from the increase in weight of the catalysts. The measured storage amounts of nitrogen dioxide in the catalysts and the amount of nitrogen dioxide estimated when barium and potassium were converted into nitrates through the reaction of barium and potassium with nitrogen dioxide are given in Table 1. Here, the “saturation degree” is a percentage of the measured nitrogen dioxide storage amount relative to the estimated nitrogen dioxide storage amount. In this case, when the saturation degree is 100%, it means that barium and potassium are completely converted into nitrates. From Table 1, the saturation degrees in a BaO(0.50)/Al₂O₃ catalyst supported with barium oxide and a K₂O(0.70)/Al₂O₃ catalyst (Comparative Example 1) supported with potassium oxide were approximately 100%. Therefore, it can be seen that nitrogen dioxide was stored in the catalysts while barium and potassium were converted into nitrates. However, the saturation degree in a K₂O(0.70)-Al₂O₃ catalyst (Example 1) chemically bonded with potassium through high-temperature calcination was 120%, which is higher. Therefore, it can be inferred that some of the alumina and nitrogen dioxide was converted into nitrates through the reaction therebetween. Since the catalysts are treated at high temperature, potassium oxide is chemically bonded with alumina, so that the alumina is activated, with the result that nitrogen oxide is stored in the activated alumina.

TABLE 1
NO₂ storage amount of K₂O—Al₂O₃ catalyst
measured at a temperature of 200° C.

| | | NO₂ storage | | |
|---|---|---|---|---|
| | | amount (mmol/g) | | |
| | Surface area | Measured | Calculated | Saturation |
| catalyst | (m²/g) | value | value | degree (%)* |
| K₂O(0.70)—Al₂O₃ | 167 | 1.57 | 1.31 | 120 |
| Al₂O₃ | 184 | 0.20 | — | — |
| BaO(0.50)/Al₂O₃ | 148 | 0.90 | 0.93 | 98 |
| K2O(0.70)/Al₂O₃ | 181 | 1.39 | 1.31 | 108 |

*Percentage of the conversion of storage materials, such as barium oxide, potassium oxide, etc. into nitrates

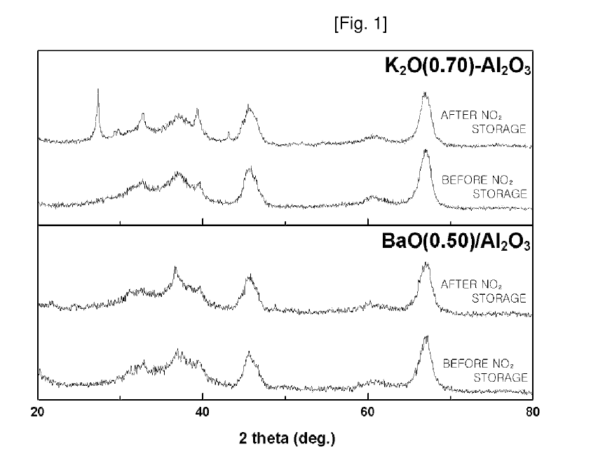

FIG. 1 shows X-ray diffraction patterns of a BaO(0.50)/Al₂O₃ catalyst (Comparative Example 1) and a K₂O(0.70)-Al₂O₃ catalyst (Example 1) before and after nitrogen dioxide was stored in the catalysts. In the BaO(0.50)/Al₂O₃ catalyst, even when nitrogen dioxide was stored therein, diffraction peaks related to nitrates did not appear. However, in the K₂O(0.70)-Al₂O₃ catalyst, when nitrogen dioxide was stored therein, new diffraction peaks appeared at angles of 27.2°, 32.8° and 39.29°. These diffraction peaks are different from those appearing in aluminum nitrate or potassium nitrate. Therefore, these new diffraction peaks are assumed to be diffraction peaks caused by nitrates made by storing nitrogen dioxide in a new material formed by bonding potassium oxide with alumina. The structure of the new material cannot be determined from the new diffraction peaks, but it can be seen that, since the new diffraction peaks are very pointed and large, the new material is a material having good crystallinity.

From the above empirical results, it can be found that the storage amount of nitrogen dioxide differs depending on whether potassium oxide is bonded with alumina or is simply supported with alumina.

### Example 2

### Change of Nitrogen Oxide Storage Amount Depending on the Amount of Potassium Oxide Bonded with Alumina and the Calcination Temperature

NSR catalysts, including alumina bonded with 0.7, 1.4, 2.3 and 3.2 mmol/g of potassium oxides, were produced using the same method as in Example. 16 kinds of NSR catalysts having different amounts of potassium oxide and calcination temperatures were produced by changing the calcination temperature into 700° C., 800° C., 900° C. and 1000° C. The nitrogen oxide storage amounts of these catalysts were measured, and then research on the effect of the amount of potassium oxide bonded with alumina and the calcination temperature on the nitrogen oxide storage amount was conducted.

The nitrogen dioxide storage amounts of the NSR catalysts, produced by changing the amount of potassium oxide bonded with alumina and the calcination temperature, are given in Table 2. The nitrogen dioxide storage amount of the NSR catalyst is sensitive to the calcination temperature. When a K₂O(3.23)-Al₂O₃ catalyst was calcined at a temperature of 800° C., the nitrogen dioxide storage amount thereof was 4.46 mmol/g, which is very high. The K₂O(3.23)-Al₂O₃ catalyst can store 0.2 g of nitrogen oxide per 1 g of catalyst, which is efficient. However, when the calcination temperature was above 900° C., the nitrogen dioxide storage amount was decreased, and thus a suitable calcination temperature was determined to be 800° C. As expected, the nitrogen dioxide storage amount was also changed depending on the amount of potassium oxide bonded with alumina. When the amount of potassium oxide bonded with alumina was increased, the nitrogen dioxide storage amount was also increased, but when the amount of potassium oxide bonded with alumina was excessively increased, the nitrogen dioxide storage amount was, conversely, decreased. That is, when a nitrate layer, formed by storing nitrogen dioxide, was thickened, the diffusion of nitrogen dioxide was prevented, and thus the nitrogen dioxide storage amount was decreased. When the amount of potassium oxide supported with alumina was 2.28 mmol/g, the maximum nitrogen dioxide storage amount was larger than the nitrogen dioxide storage amount calculated based on the amount of potassium oxide. In contrast, when the amount of potassium oxide supported with alumina was above 3.23 mmol/g, the maximum nitrogen dioxide storage amount was smaller than the nitrogen dioxide storage amount calculated based on the amount of potassium oxide.

TABLE 2
Nitrogen dioxide storage amounts of a K₂O—Al₂O₃ catalyst, produced by changing the
amount of K₂O supported with alumina and the calcination temperature

| | NO2 storage amount (mmol/g) | | | | |
|---|---|---|---|---|---|
| | Measured value | | | | |
| catalyst | 700° C.* | 800° C.* | 900° C.* | 1000° C.* | Calculated value |
| K₂O(0.68)—Al₂O₃ | 1.66 | 1.56 | 1.56 | 1.45 | 1.30 |
| K₂O(1.44)—Al₂O₃ | 2.54 | 3.04 | 2.95 | 2.75 | 2.59 |
| K₂O(2.28)—Al₂O₃ | 3.23 | 3.69 | 3.35 | 4.10 | 3.86 |
| K₂O(3.23)—Al₂O₃ | 2.51 | 4.46 | 3.08 | 1.17 | 5.17 |

*calcination temperature

### Example 3

### Production of BaO(0.50)/K₂O(0.70)-Al₂O₃

20 g of K₂O(0.70)-Al₂O₃ catalyst, including alumina bonded with potassium oxide, produced in Example 1, was added to a solution formed by dissolving 3.61 g of barium acetate in 200 g of water to form a mixed solution. The mixed solution was sufficiently stirred for 2 hours, and then water was removed therefrom using a rotation evaporator. Subsequently, the resulting product was dried at a temperature of 100° C., and was then calcined in an electrical calcination furnace at a temperature of 550° C. for 4 hours to produce a catalyst including alumina supported with barium oxide. In the produced catalyst, the amount of barium oxide, supported with alumina, was 0.50 mmol/galumina, and the catalyst was represented by BaO(0.50)/K₂O(0.70)-Al₂O₃ catalyst. The nitrogen oxide storage amount of the BaO(0.50)/K₂O(0.70)-Al₂O₃ catalyst, including alumina additionally supported with barium oxide, is given in Table 3. The BaO(0.50)/K₂O(0.70)-Al₂O₃ catalyst, including alumina additionally supported with barium oxide, stored a larger amount of nitrogen oxide. In the present invention, even when barium oxide is supported on the alumina of the catalyst in an amount up to 5 mmol/g, similar effects were obtained.

TABLE 3
Nitrogen dioxide storage amount of K₂O—Al₂O₃ catalyst
including alumina supported with barium oxide

| | NO₂ storage amount (mmol/g) | |
|---|---|---|
| catalyst | Measured value | Calculated value |
| K₂O(0.70)—Al₂O₃ | 1.57 | 1.31 |
| BaO(0.50)/K₂O(0.70)—Al₂O₃ | 2.17 | 2.40 |

Meanwhile, in order to evaluate the ability of the catalyst to withstand hydrothermal treatment, the nitrogen dioxide storage amount and the reduction-removal performance of the catalyst were examined. K₂O(0.70)-Al₂O₃ (Example 1) and BaO(0.50)/K₂O(0.70)-Al₂O₃ (Example 3) catalysts were hydrothermally treated in a state in which they were put into an alumina pottery bowl, and then the bowl was put into a quartz tube located in a calcination furnace. A mixed gas of nitrogen and water vapor, including 10% by volume of the water vapor, was prepared by flowing nitrogen into a water vaporizer placed in an isothermal water bath. The catalysts were hydrothermally treated while applying the mixed gas to the catalysts at a flow rate of 100 ml/min at a temperature of 750° C. for 4 hours. The catalysts tailed with ‘-aged’ refer to hydrothermally-treated catalysts.

The nitrogen dioxide storage amount of the catalysts, measured after the hydrothermal treatment, is given in Table 4. It was found that, since the nitrogen dioxide storage amount of the NSR catalyst including alumina fixed with potassium oxide was hardly changed even after the hydrothermal treatment thereof, the NSR catalyst had excellent hydrothermal stability.

TABLE 4
NO2 storage amount of K₂O—Al₂O₃ catalyst

| | NO₂ storage amount (mmol/g) | |
|---|---|---|
| | Before hydrothermal | After hydrothermal |
| catalyst | treatment | treatment |
| K₂O(0.70)—Al₂O₃ | 1.57 | 1.76 |
| BaO(0.70)/K₂O(0.70)—Al₂O₃ | 2.17 | 2.26 |

Since nitrogen oxides stored in the NSR catalyst must be reduced into nitrogen while being desorbed from the NSR catalyst under reduction conditions, it is important for the NSR catalyst to have a function of reducing and removing the nitrogen dioxide desorbed therefrom in addition to a function of storing nitrogen dioxide therein. The reduction ability of the NSR catalyst of the present invention was measured in the following Examples.

### Example 4

### Production of Pt(2)/K₂O(0.70)-Al₂O₃ Catalyst

In order to evaluate the performance of reducing and removing nitrogen dioxide desorbed from catalysts, a Pt(2)/K₂O(0.70)-Al₂O₃ catalyst, which is a K₂O(0.70)-Al₂O₃ catalyst (Example 1) supported with 2% by weight of platinum, was produced through an impregnation method. 10 g of a K₂O(0.70)-Al₂O₃ catalyst was added to a solution formed by dissolving 0.36 g of ammonium chloroplatinate, which is a precious metal precursor, in 100 g of water to form a mixed solution. The mixed solution was stirred for 2 hours, and then water was removed therefrom using a rotation evaporator. Subsequently, the resulting product was calcined in an electrical calcination furnace at a temperature of 550° C. for 4 hours to produce an NSR catalyst including alumina supported with platinum.

### Comparative Example 2

### Production of Pt(2)/Al₂O₃ and Pt(2)-BaO(0.50)/Al₂O₃ Catalysts

For comparison, a Pt(2)/Al₂O₃ catalyst including alumina supported with platinum and a Pt(2)-BaO(0.50)/Al₂O₃ catalyst supported with platinum and barium oxide were produced.

The performance of reducing and removing the nitrogen dioxide desorbed from catalysts was evaluated using an infrared spectrometer provided with a gas cell. 15 mg of a catalyst was pressed into a plate-shaped catalyst, and the plate-shaped catalyst was placed on a sample support in the gas cell and was then exposed to exhaust gases at a temperature of 500° C. for 1 hour. Subsequently, the catalyst was cooled to a temperature of 200° C., and then exposed to nitrogen dioxide gas of 5 Torr for 20 minutes, and thus nitrogen dioxide was stored in the catalyst. In this state, an infrared absorption spectrum was photographed. Subsequently, the catalyst was exposed to hydrogen gas of 15 Torr for 20 minutes, and then the degree of the reduction and removal of nitrogen dioxide in a reducing atmosphere was evaluated.

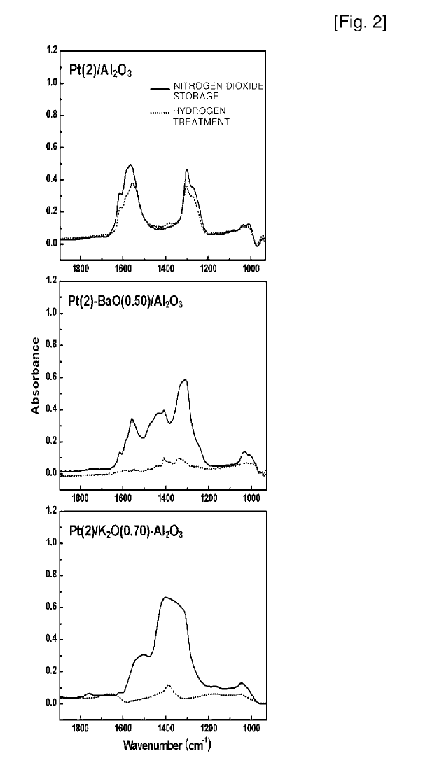

In FIG. 2, the reduction behaviors of nitrogen dioxide stored in an NSR catalyst that was not hydrothermally treated are compared. In the Pt(2)/Al₂O₃ catalyst including alumina supported with platinum, a nitrate absorption band appeared, because nitrogen dioxide was stored therein. In the Pt(2)-BaO(0.50)/Al₂O₃ catalyst including alumina supported with platinum and barium oxide, a new nitrate absorption band appeared because nitrogen dioxide was stored in the form of nitrate therein. In contrast, In the Pt/K₂O(0.70)-Al₂O₃ catalyst, including alumina supported with potassium oxide, an ion-state nitrate absorption band appeared. When hydrogen was supplied, and thus nitrogen dioxide was reduced, the reduction behaviors of nitrogen dioxide differed depending on the kind of catalyst. In the Pt(2)/Al₂O₃ catalyst, nitrogen dioxide stored therein was not reduced, and was removed even when hydrogen was supplied. In contrast, in the Pt(2)-BaO(0.50)/Al₂O₃ catalyst and Pt(2)/K₂O(0.70)-Al₂O₃ catalyst, nitrogen dioxide stored therein was mostly reduced and removed.

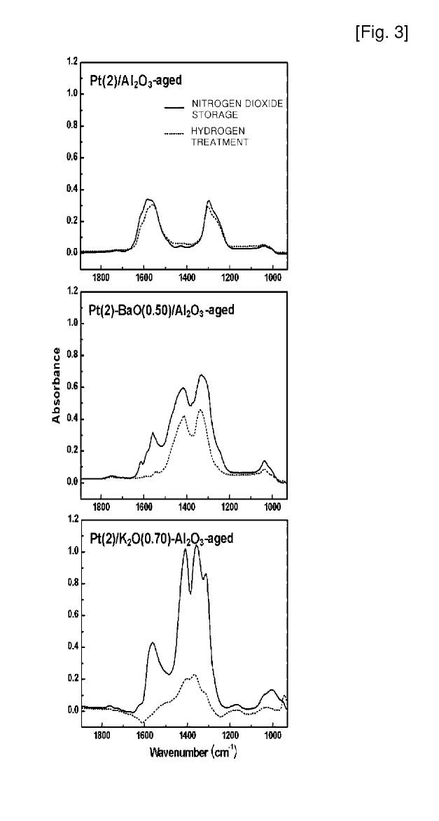

However, the reduction and removal behaviors of nitrogen dioxide stored in an NSR catalyst after hydrothermal treatment were very different. As shown in FIG. 3, the storage behavior of nitrogen dioxide after hydrothermal treatment was almost the same as that before hydrothermal treatment. However, the reduction and removal behaviors of nitrogen dioxide differed depending on the kind of catalyst. In the Pt(2)/Al₂O₃ catalyst, almost no nitrogen dioxide was reduced and removed, the same as before the hydrothermal treatment. In the Pt(2)-BaO(0.50)/Al₂O₃ catalyst, the performance of reducing and removing nitrogen dioxide was greatly decreased compared to before the hydrothermal treatment. In contrast, in the Pt(2)/K₂O(0.70)-Al₂O₃ catalyst, most nitrogen dioxide was reduced and removed by hydrogen, the same as before hydrothermal treatment. Therefore, in the alumina catalyst of the present invention, chemically bonded with potassium oxide, the dispersity of precious metal was high even after hydrothermal treatment, and thus the performance of reducing and removing nitrogen dioxide in the catalyst was maintained. According to the large number of experiments by the present inventors, even when only 0.5-2 wt % of precious metals, such as platinum, palladium, rhodium and the like, were supported in the catalyst of the present invention, the effect of the present invention was not decreased.

1. A method of producing a catalyst for storing nitrogen oxides, comprising: supporting a potassium oxide on alumina, which serves as a support, and then calcining the alumina supported with the potassium oxide at a high temperature, thus chemically bonding potassium oxide with the alumina.

2. The method according to claim 1, further comprising, after the chemical bonding of the potassium oxide with the alumina: supporting barium oxide on the alumina, which serves as a support.

3. The method according to claim 1 or 2, further comprising: supporting one or more selected from among platinum, palladium and rhodium to reduce nitrogen dioxide.

4. The method according to claim 1, wherein the chemical bonding of the potassium oxide with the alumina is conducted through calcinations at a temperature of 750˜1000° C.

5. The method according to claim 1, wherein an amount of the potassium oxide chemically bonded with the alumina is 0.7-3.3 mmol/g.

6. A catalyst for storing nitrogen oxides, produced using the method according to claim 1.

7. The method according to claim 1, further comprising: supporting one or more selected from among platinum, palladium and rhodium to reduce nitrogen dioxide.

8. The method according to claim 1, wherein the chemical bonding of the potassium oxide with the alumina is conducted through calcinations at a temperature of 750˜1000° C.

9. The method according to claim 2, wherein an amount of the potassium oxide chemically bonded with the alumina is 0.7-3.3 mmol/g.

10. A catalyst for storing nitrogen oxides, produced using the method according to claim 2.
